(19) United States
(12) Patent Application Publication
(10) Pub. No.: US 2025/0173551 A1
(43) Pub. Date: May 29, 2025

(54) LANGUAGE MODEL TRAINING METHOD AND COMPUTING DEVICE

(71) Applicant: SAMSUNG ELECTRONICS CO., LTD., Suwon-si (KR)

(72) Inventors: Nuri HAN, Suwon-si (KR); Gilhwan KIM, Suwon-si (KR); Jiwon SEO, Suwon-si (KR); Jihyung OH, Suwon-si (KR); Jinwoo LEE, Suwon-si (KR); JongHee HA, Suwon-si (KR); Junghwan KIM, Suwon-si (KR); Moonhwan PARK, Suwon-si (KR); Do-Young SHIN, Suwon-si (KR); Yohwan JOO, Suwon-si (KR)

(73) Assignee: SAMSUNG ELECTRONICS CO., LTD., Suwon-si (KR)

(21) Appl. No.: 18/742,618

(22) Filed: Jun. 13, 2024

(30) Foreign Application Priority Data
Nov. 23, 2023 (KR) 10-2023-0164433

(51) Int. Cl. G06N 3/0455

(52) U.S. Cl. CPC G06N 3/0455

(57) ABSTRACT

A language model training method includes: obtaining first data comprising semiconductor equipment data; performing preprocessing on the first data to generate second data; generating a first token from the second data using a mapping table; and generating a semiconductor language model by performing unsupervised learning on a language model using the first token.

### CROSS-REFERENCE TO RELATED APPLICATION

This application is based on and claims priority to Korean Patent Application No. 10-2023-0164433, filed on Nov. 23, 2023, in the Korean Intellectual Property Office, the disclosure of which is incorporated by reference herein in its entirety.

### BACKGROUND

### 1. Field

The present disclosure relates to a language model training method and a computing device.

### 2. Description of Related Art

If a failure occurs while operating semiconductor equipment, an operator may find previous similar cases in the semiconductor equipment data and refer to an action to take. Because a huge amount of semiconductor equipment data is accumulated every day in the semiconductor production environment, it is desirable to summarize the semiconductor equipment data in order to analyze how to take action on failures.

Some approaches for summarizing semiconductor equipment data using artificial neural networks are limited to generating summaries that consider the overall context of the semiconductor equipment data, but may be unable to generate summaries that can assist with failure actions.

### SUMMARY

Provided is a method of training an artificial neural network based on semiconductor data.

Also provided is a method of summarizing failure data by using an artificial neural network.

Additional aspects will be set forth in part in the description which follows and, in part, will be apparent from the description, or may be learned by practice of the presented embodiments.

In accordance with an aspect of the disclosure, a language model training method includes: obtaining first data comprising semiconductor equipment data; performing preprocessing on the first data to generate second data; generating a first token from the second data using a mapping table; and generating a semiconductor language model by performing unsupervised learning on a language model using the first token.

In accordance with an aspect of the disclosure, a language model training method includes inputting first data comprising semiconductor equipment data into an artificial neural network, and obtaining second data comprising failure data output from the artificial neural network; obtaining correction data indicating an appropriateness of the second data; and updating a weight of the artificial neural network based on the first data, the second data, and the correction data.

In accordance with an aspect of the disclosure, a computing device includes a machine learning module configured to: perform unsupervised learning on an artificial neural network using semiconductor equipment data to generate a semiconductor language model, and perform supervised learning on the semiconductor language model based on the semiconductor equipment data, label data, and correction data to generate a semiconductor inference model; and an inference module configured to generate a summary of the semiconductor equipment data based on the semiconductor language model and the artificial neural network.

### BRIEF DESCRIPTION OF THE DRAWINGS

FIG. 1 is a block diagram illustrating a semiconductor system according to an embodiment;

FIG. 2 is a block diagram illustrating a computing device according to an embodiment;

FIGS. 3 to 5 are flowcharts of a language model training method performed by a machine learning module according to an embodiment;

FIG. 6 is a diagram illustrating an operation of a semiconductor language model according to an embodiment;

FIG. 7 is a flowchart of a language model training method performed by a machine learning module according to an embodiment;

FIG. 8 is a diagram illustrating examples of third data and first label data according to an embodiment;

FIG. 9 is a flowchart of a language model training method performed by a machine learning module according to an embodiment;

FIG. 10 is a diagram illustrating supervised learning performed by a machine learning module according to an embodiment;

FIG. 11 is a diagram illustrating an example of an interface provided by a computing device according to an embodiment;

FIGS. 12 and 13 are flowcharts of a summary data generating method performed by an inference module according to an embodiment;

FIG. 14 is a diagram illustrating a summary data generating method performed by an inference module according to an embodiment;

FIGS. 15 and 16 are flowcharts illustrating a language model training method performed by a machine learning module according to an embodiment;

FIGS. 17 and 18 are flowcharts illustrating a summary data generating method performed by an inference module according to an embodiment;

FIG. 19 is a diagram illustrating a configuration in which the inference module generates a summary according to an embodiment;

FIG. 20 is a diagram illustrating an operation of a semiconductor system according to an embodiment;

FIG. 21 is a diagram illustrating an operation of a semiconductor system according to an embodiment;

FIGS. 22 to 24 are diagrams illustrating a data management method according to an embodiment; and

FIG. 25 is a diagram illustrating a method of generating a relationship graph according to an embodiment.

### DETAILED DESCRIPTION OF THE EXEMPLARY EMBODIMENTS

In the following detailed description, only certain embodiments of the disclosure are shown and described, simply by way of illustration. As those skilled in the art will realize, the described embodiments may be modified in various different ways without departing from the spirit or scope of the disclosure.

Accordingly, the drawings and description are to be regarded as illustrative in nature and not restrictive. Like reference numerals designate like elements throughout the disclosure. In the flowchart described with reference to the drawing, the order of operations may be changed, several operations may be merged, some operations may be divided, and specific operations may not be performed.

In addition, expressions written in the singular may be construed in the singular or plural unless an explicit expression such as “a” or “single” is used. Terms including an ordinary number, such as first and second, are used for describing various constituent elements, but the constituent elements are not limited by the terms. These terms may be used to distinguish one component from another component.

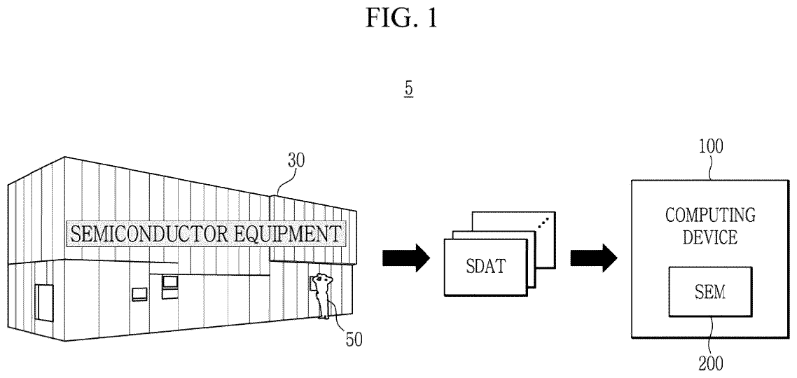

FIG. 1 is a block diagram illustrating a semiconductor system according to an embodiment.

Referring to FIG. 1, a semiconductor system 5 according to an embodiment may include semiconductor equipment 30 and a computing device 100. The semiconductor equipment 30 may be equipment used in a process for producing a semiconductor device. For example, the semiconductor equipment 30 may be pre-processing equipment that performs oxidation, deposition, exposure, etching, or the like, or post-processing equipment that performs packaging, testing, or the like. In one or more embodiments, the semiconductor equipment 30 may be equipment used in a process to produce a display device or a substrate.

The computing device 100 may receive semiconductor data SDAT and determine a state of the semiconductor equipment 30. In one or more embodiments, the computing device 100 may monitor the semiconductor equipment 30. For example, the computing device 100 may predict a failure of the semiconductor equipment 30. The computing device 100 may diagnose a cause of the failure when the semiconductor equipment 30 fails. The computing device 100 may recommend an action to resolve the failure when the semiconductor equipment 30 fails.

The computing device 100 may include a semiconductor equipment module 200 (illustrated as “SEM”). The semiconductor equipment module 200 may include an artificial neural network and may train the artificial neural network. In one or more embodiments, the semiconductor equipment module 200 may perform unsupervised learning on an artificial neural network to generate a semiconductor language model. The semiconductor equipment module 200 may perform unsupervised learning by using semiconductor data SDAT.

In one or more embodiments, the semiconductor equipment module 200 may perform supervised learning on an artificial neural network to generate a semiconductor inference model. The data output by the semiconductor inference model may be determined according to the training data set used by the semiconductor equipment module 200. For example, the training data may include semiconductor data SDAT and label data, and the label data may be failure cause data or failure action data, and the like. In some embodiments, the semiconductor equipment module 200 may perform supervised learning on a semiconductor language model to generate a semiconductor inference model. The semiconductor equipment module 200 may determine the state of the semiconductor equipment 30 using a trained artificial neural network.

Semiconductor data SDAT may be data related to semiconductor equipment (which may be referred to as “semiconductor equipment data”). For example, the semiconductor equipment data may include at least one of operational results data generated while the semiconductor equipment 30 operates, and operational reporting data created by a user 50 operating the semiconductor equipment 30. The operational reporting data may include data indicating an action taken on the semiconductor equipment 30 in response to any failures (which may be referred to as “action data”). In one or more embodiments, the semiconductor data SDAT may include documents, web pages, reports, papers, presentations, training materials, and the like in the field of semiconductor technology. In one or more embodiments, the semiconductor data SDAT may include any combination of the data described above.

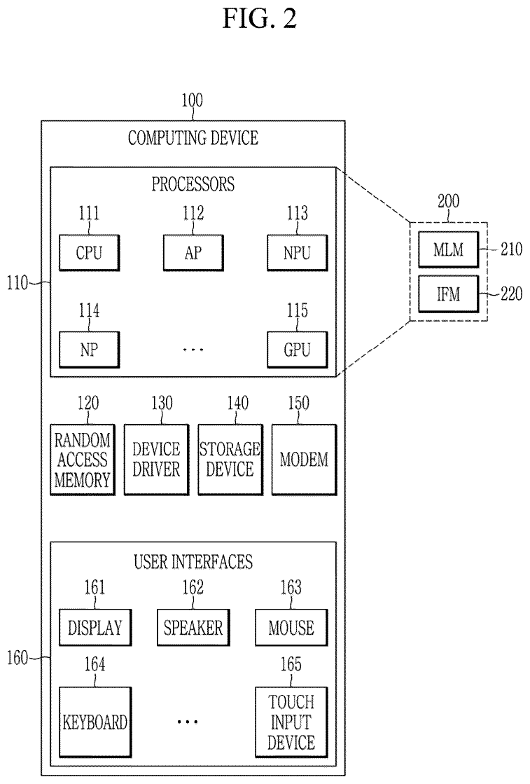

FIG. 2 is a block diagram illustrating a computing device according to an embodiment.

Referring to FIG. 2, the computing device 100 may include processors 110, a random access memory 120, a device driver 130, a storage device 140, a modem 150, and a user interface 160.

At least one of the processors 110 may execute the semiconductor equipment module 200. The semiconductor equipment module 200 may execute a machine learning module 210 (illustrated as “MLM”) and an inference module 220 (illustrated as “IFM”). The machine learning module 210 and the inference module 220 may generate summaries related to the operation of the semiconductor equipment based on machine learning.

In one or more embodiments, the machine learning module 210 and the inference module 220 may predict a failure of the semiconductor equipment. The machine learning module 210 and the inference module 220 may diagnose the cause of the failure in the semiconductor equipment when the failure occurs. The machine learning module 210 and the inference module 220 may recommend an action method to resolve the failure when the semiconductor equipment has failed. The machine learning module 210 and the inference module 220 may generate a summary that includes the cause of the failure and/or the action method.

The machine learning module 210 may train an artificial neural network. For example, the machine learning module 210 may train an artificial neural network using at least one of unsupervised learning and supervised learning to generate a semiconductor language model, a semiconductor inference model, or the like. The semiconductor language model, the semiconductor inference model, and the like may be used by the inference module 220 to generate summaries. A semiconductor language model may be a model that outputs a vector corresponding to the input data by using layers, nodes, weights, and the like when receiving input of data. A semiconductor inference model may be a model that outputs failure data corresponding to the input data by using layers, nodes, weights, and the like when receiving input of data.

The machine learning module 210 may perform unsupervised learning on an artificial neural network using semiconductor data to generate a semiconductor language model. In one or more embodiments, the semiconductor data may include semiconductor equipment data, such as at least one of operational result data and operational reporting data. In one or more embodiments, the semiconductor data may include documents, web pages, reports, papers, presentations, training materials, and the like, for example in the field of semiconductor technology. In one or more embodiments, the semiconductor data may include any combination of the data described above.

The machine learning module 210 may perform supervised learning on an artificial neural network using the training data set to generate a semiconductor inference model. In some embodiments, the machine learning module 210 may also perform supervised learning on a semiconductor language model by using the training data set to generate a semiconductor inference model.

The training data set may include semiconductor equipment data and failure data. In one or more embodiments, the failure data may be label data. For example, the machine learning module 210 may train the semiconductor inference model to output failure data based on the semiconductor equipment data.

According to embodiments, the semiconductor equipment data may be implemented as operation result data or operation reporting data, and the failure data may be implemented as failure cause data or failure action data of the semiconductor equipment. For example, the training data set may include at least one of operation result data and operation reporting data, and at least one of failure cause data and failure action data.

The inference module 220 may generate a summary using the at least one model generated by the machine learning module 210. For example, the semiconductor language model generated by the machine learning module 210 may output a vector based on receiving input of semiconductor data. The semiconductor inference model generated by the machine learning module 210 may output failure data based on receiving input of semiconductor data. The inference module 220 may generate a summary based on at least one of the vector and failure data output by the model. In one or more embodiments, the summary may be summary data of the semiconductor data input to the model.

The inference module 220 may obtain hardware information of the semiconductor equipment. For example, the storage device 140 (or for example a database) may store hardware information of the semiconductor equipment, and the inference module 220 may obtain hardware information from the storage device 140. The inference module 220 may generate a summary based on the hardware information.

In one or more embodiments, the machine learning module 210 and the inference module 220 may be implemented in the form of instructions (or for example codes) executed by at least one of the processors 110. In this case, at least one processor may load the instructions (or codes) of the machine learning module 210 and the inference module 220 into the random access memory 120.

In some embodiments, at least one processor may be used to implement the machine learning module 210 and the inference module 220. As another example, at least one processor may be used to implement various machine learning modules. At least one processor may implement the machine learning module 210 and the inference module 220 by receiving information corresponding to the machine learning module 210 and the inference module 220.

The processors 110 may include at least one general purpose processor, such as, for example, a central processing unit 111 (illustrated as “CPU”), and an application processor 112 (illustrated as “AP”). The processors 110 may also include at least one special purpose processor, such as a neural processing unit 113 (illustrated as “NPU”), a neuromorphic processor 114 (illustrated as “NP”), and a graphics processing unit 115 (illustrated as “GPU”). The processors 110 may include two or more processors of the same type.

The random access memory 120 may be used as operational memories for the processors 110, and may be used as a main memory or a system memory for the computing device 100. The random access memory 120 may include a volatile memory, such as a dynamic random access memory or a static random access memory, or a non-volatile memory, such as a phase change random access memory, a ferroelectric random access memory, a magnetic random access memory, or a resistive random access memory. According to one or more embodiments, the processors 110 and the memory 120 may be implemented in a single-chip structure. For example, the processors 110 and the memory 120 may be implemented as a System on Chip (SoC) or a System in Package (SiP).

The device driver 130 may control peripheral devices, such as the storage device 140, the modem 150, and the user interfaces 160, as requested by the processors 110. The storage device 140 may include a fixed storage device, such as a hard disk drive (HDD) or a solid state drive (SSD), or a removable storage device, such as an external hard disk drive, an external solid state drive, or a removable memory card.

The modem 150 may provide remote communication with an external device. The modem 150 may perform wireless or wired communication with an external device. The modem 150 may communicate with an external device via at least one of various forms of communication, such as Ethernet, Wi-Fi, LTE, or 5G mobile cellular communication.

The user interfaces 160 may receive information from the user and provide information to the user. The user interfaces 160 may include at least one user output interface, such as a display 161, a speaker 162, and the like, and at least one user input interface, such as a mouse 163, a keyboard 164, and a touch input device 165. According to one or more embodiments, the user interfaces 160 may further include other user interfaces, or may not include at least one of the illustrated user interfaces 160.

The instructions (or codes) of the machine learning module 210 and the inference module 220 may be received via the modem 150 and stored in the storage device 140. The instructions (or codes) of the machine learning module 210 and the inference module 220 may be stored in a removable storage device and coupled to the computing device 100. The instructions (or codes) of the machine learning module 210 may be loaded into the random access memory 120 from the storage device 140 and executed.

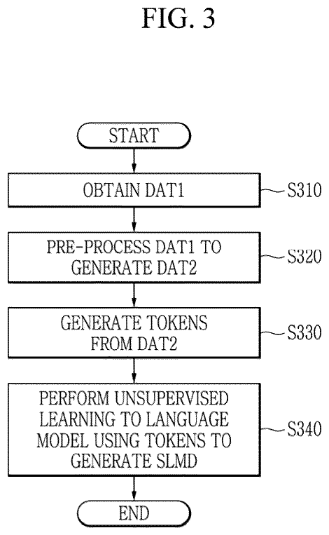

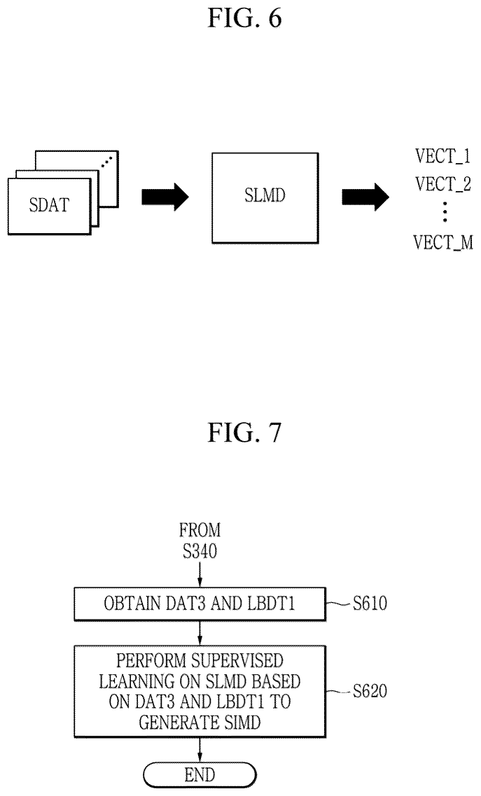

FIGS. 3, 4 and 5 are flowcharts of a language model training method performed by the machine learning module 210 according to one or more embodiments, and FIG. 6 is a diagram illustrating an operation of the semiconductor language model according to one or more embodiments.

Referring to FIG. 3, the machine learning module 210 according to one or more embodiments may perform unsupervised learning on an artificial neural network. The machine learning module 210 may obtain first data DAT1 at operation S310. The first data DAT1 may be semiconductor equipment data. The semiconductor equipment data may include at least one of operation result data generated while the semiconductor equipment operates, and operation reporting data created by a user operating the semiconductor equipment. In one or more embodiments, the machine learning module 210 may use the operational result data or the operational reporting data as the first data DAT1. In one or more embodiments, the machine learning module 210 may use the operational result data and the operational reporting data as the first data DAT1.

The machine learning module 210 may perform preprocessing on the first data DAT1 to generate second data DAT2 at operation S320. For example, the machine learning module 210 may perform preprocessing, such as segmentation or stopword removal.

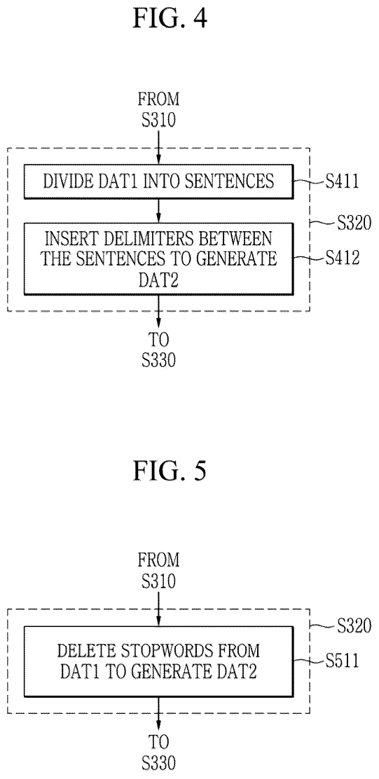

FIG. 4 shows an example of operation S320, according to one or more embodiments. Referring to FIG. 4, the machine learning module 210 according to embodiments may segment the first data DAT1 into sentence units at operation S411. However, embodiments are not limited thereto, and in some embodiments the machine learning module 210 may segment the first data DAT1 in the unit of word, morpheme, and the like.

The machine learning module 210 may generate the second data DAT2 by inserting delimiters between the segmented sentences at operation S412. The machine learning module 210 may insert the delimiter at the beginning and/or the end of the sentence. For example, the machine learning module 210 may insert a special classification token, which may be referred to as a CLS token, at the beginning of a sentence. In one example, the machine learning module may insert a special separator token, which may be referred to as a SEP token, at the end of the sentence.

FIG. 5 shows another example of operation S320, according to embodiments. Referring to FIG. 5, the machine learning module 210 according to embodiments may remove a stopword from the first data DAT1 to generate the second data DAT2. For example, the stopword may refer to elements, such as user names, dates, or special characters, that is unnecessary for training the semiconductor language model.

According to one or more embodiments, operations S411, S412 of FIG. 4 and operation S511 of FIG. 5 may be performed together. For example, the machine learning module 210 may segment the first data DAT1 in the unit of sentence, insert delimiters, and remove stopwords to generate the second data DAT2.

Further, according to one or more embodiments, the order of the preprocessing operations (for example, segmenting, inserting, and removing) of the machine learning module 210 may be implemented differently. For example, the machine learning module 210 may perform the preprocessing operations in various combinations, such as the order of segmenting, removing, and inserting, or the order of removing, segmenting, and inserting.

Referring again to FIG. 3, the machine learning module 210 may generate tokens from the second data DAT2 at operation S330. The machine learning module 210 may perform the tokenization by using a mapping table that includes a corresponding relationship between sentences and tokens. For example, the machine learning module 210 may generate a first token from a first sentence of the second data DAT2, and a second token from a second sentence.

The machine learning module 210 may generate a semiconductor language model by performing unsupervised learning on an artificial neural network using the tokens at operation S340. In one or more embodiments, the machine learning module 210 may perform unsupervised learning by using a masked language model (MLM). The machine learning module 210 may transform at least one of the tokens to a mask token and set parameters, such as weights, of the artificial neural network so that the remaining tokens may predict the mask token. In one or more embodiments, the machine learning module 210 may perform unsupervised learning by using next sentence prediction (NSP). The machine learning module 210 may make the artificial neural network to learn the relationship between two sentences by using the NSP.

Referring to FIG. 6, the semiconductor language model SLMD may be completely trained by the machine learning module 210. The semiconductor language model SLMD may receive input of semiconductor data SDAT. The semiconductor language model SLMD may output vectors VECT_1 to VECT_M (where M is an integer greater than 2) corresponding to the semiconductor data SDAT based on parameter values set through the training. The vectors VECT_1 to VECT_M may be used as embedding vectors in the artificial neural network. The artificial neural network may generate inference data by using the vectors VECT_1 to VECT_M.

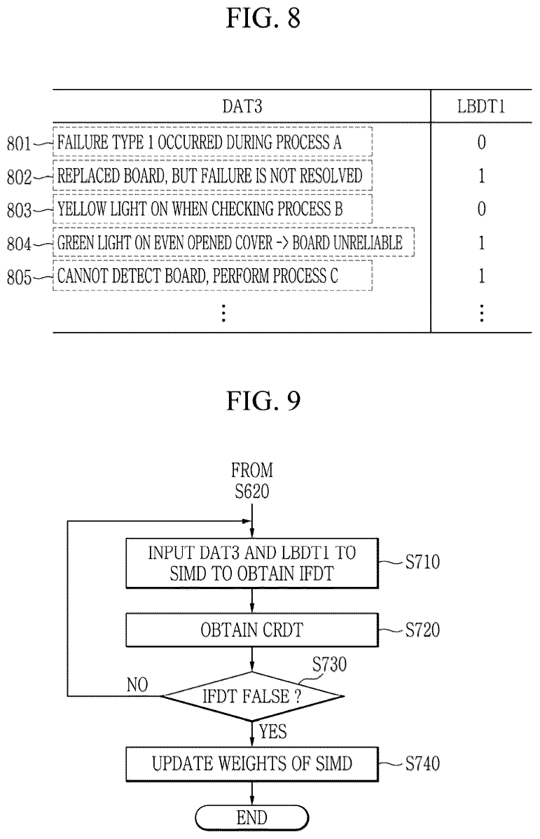

FIG. 7 is a flowchart of the language model training method performed by the machine learning module 210 according to one or more embodiments, and FIG. 8 is a diagram illustrating examples of third data and first label data according to one or more embodiments.

Referring to FIG. 7, the machine learning module 210 may obtain third data DAT3 and first label data LBDT1 corresponding to the third data DAT3 at operation S610. The third data DAT3 and the first label data LBDT1 may be a training data set for performing supervised learning on the semiconductor language model SLMD of FIG. 6. The third data DAT3 may be semiconductor equipment data. In one or more embodiments, the third data DAT3 may be the same as, or different from, the first data DAT1 of FIG. 3. In some embodiments, the machine learning module 210 may perform preprocessing on the third data DAT3.

The first label data LBDT1 may have a value of zero (“0”) or one (“1”). For example, the first label data LBDT1 may have a value of one (“1”) for failure data in the third data DAT3. The first label data LBDT1 may have a value of zero (“0”) for data that is not failure data in the third data DAT3. In one or more embodiments, the machine learning module 210 may obtain data (which may be referred to as “failure action data”) in the third data DAT3 that relates to the action taken to resolve the failure of the semiconductor equipment. The machine learning module 210 may determine a value of the first label data LBDT1 as a first value for the failure action data. In one or more embodiments, the machine learning module 210 may obtain data indicating a cause of the failure of the semiconductor equipment (which may be referred to as “failure cause data”) in the third data DAT3. The machine learning module 210 may determine a value of the first label data LBDT1 as a first value for the failure cause data. In some embodiments, the first value may be 1.

Referring to FIG. 8, the machine learning module 210 may obtain the third data DAT3 and the first label data LBDT1. In the example of FIG. 8, the third data DAT3 is operational reporting data among semiconductor equipment data, and the first label data LBDT1 may have a first value (for example, a value of one (“1”)) for failure action data in the third data DAT3.

The third data DAT3 according to one or more embodimentsmay include sentences such as sentence 801 (“failure type 1 occurred during process A”), sentence 802 (“replaced board, but failure is not resolved”), sentence 803 (“yellow light on when checking process B”), sentence 804 (“green light on even opened cover→board unreliable”), sentence 805 (“cannot detect board, perform process C”), and the like. The first label data LBDT1 may have a first value for the failure action data in the third data DAT3. For example, the first label data LBDT1 may have a first value (for example, a value of one (“1”)) for sentences 802, 804, and 805 that are the failure action data, such as replace board, open cover, and perform process C. The first label data LBDT1 may have a second value (for example, a value of zero (“0”)) for sentences 801 and 803 that are not failure action data.

Referring again to FIG. 7, the machine learning module 210 may perform supervised learning on the semiconductor language model SLMD based on the third data DAT3 and the first label data LBDT1 to generate a semiconductor inference model SIMD at operation S620. The semiconductor inference model SIMD may be trained to output failure data based on the input data. For example, when the input data is received, the semiconductor inference model SIMD may output a value (e.g., a real number between (“0”) and one (“1”)) corresponding to the input data. In one or more embodiments, based on receiving input data that is more likely to be associated with failure data, the semiconductor inference model SIMD may output a value closer to one (“1”). In embodiments, based on receiving input data that is more likely to be associated with failure data, the semiconductor inference model SIMD may output a value closer to zero (“0”). Based on the value output by the semiconductor inference model SIMD, the failure data may be selected from the third data DAT3.

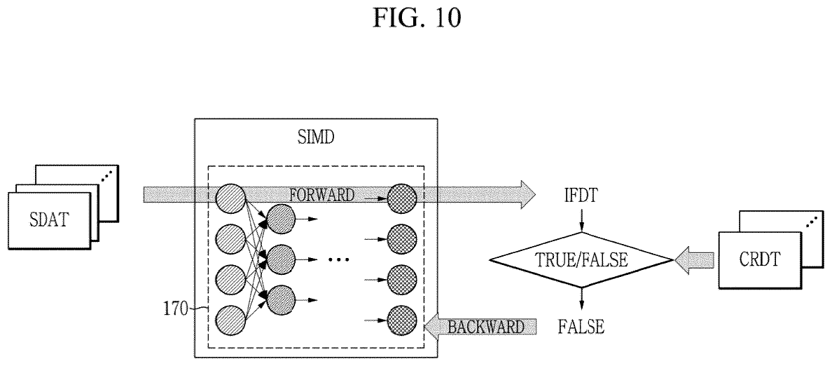

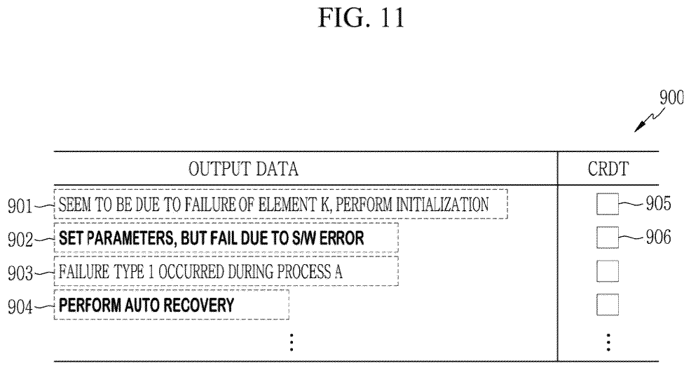

FIG. 9 is a flowchart of a language model training method performed by a machine learning module according to an embodiment, FIG. 10 is a diagram illustrating supervised learning performed by a machine learning module according to an embodiment, and FIG. 11 is a diagram illustrating an example of an interface provided by a computing device according to an embodiment.

Referring to FIG. 9, the machine learning module 210 according to one or more embodiments may input the third data DAT3 and the first label data LBDT1 into the semiconductor inference model SIMD and obtain inference data IFDT at operation S710. The inference data IFDT may be a real number ranging from zero (“0”) to less than or equal to one (“1”), which may be an importance value indicating the degree of association with the failure data. For example, the semiconductor inference model SIMD may output inference data IFDT corresponding to the third data DAT3 and the first label data LBDT1 based on the parameter values set through the training in operation S620 of FIG. 7. In FIG. 9, for ease of explanation, it is illustrated that the machine learning module 210 uses the third data DAT3 and the first label data LBDT1, but embodiments are not limited thereto, and in some embodiments the machine learning module 210 may use any semiconductor data and failure data other than the third data DAT3 and the first label data LBDT1.

The machine learning module 210 may obtain correction data CRDT representing an appropriateness of the inference data IFDT at operation S720. In one or more embodiments, the appropriateness of the inference data IFDT may refer to a determination of whether the inference data IFDT is true or false. For example, the inference data IFDT may be true when it correctly corresponds to the first label data LBDT1, and the inference data IFDT may be false when it does not correctly correspond to the first label data LBDT1. The user may input the correction data CRDT representing the appropriateness of the inference data IFDT into the machine learning module 210. For example, the computing device 100 of FIG. 2 may provide an interface for the user to input the correction data CRDT. The machine learning module 210 may receive the correction data CRDT from the user through the interface.

The machine learning module 210 may determine the appropriateness of the inference data IFDT based on the correction data CRDT at operation S730. The machine learning module 210 may determine that the inference data IFDT is false when the correction data CRDT is input. The machine learning module 210 may determine that the inference data IFDT is true when the correction data CRDT is not input.

The machine learning module 210 may update the weight of the semiconductor inference model SIMD when the inference data IFDT is determined to be false at operation S740. The machine learning module 210 may update the weight of the semiconductor inference model SIMD based on the third data DAT3, the first label data LBDT1, the inference data IFDT, and the correction data CRDT.

Referring to FIG. 10, the machine learning module 210 according to one or more embodiments may input semiconductor data SDAT to the semiconductor inference model SIMD. The semiconductor inference model SIMD may include a plurality of nodes 170 and may be trained to output inference data IFDT based on the semiconductor data SDAT. The plurality of nodes 170 may have weights set through training, and may perform computations on the weights and the semiconductor data SDAT to generate inference data IFDT. The inference data IFDT may be a real number greater than zero (“0”) and less than or equal to one (“1”).

The machine learning module 210 may receive the correction data CRDT. For example, a user may input the correction data CRDT using the computing device 100 of FIG. 2. The machine learning module 210 may determine the appropriateness of the inference data IFDT based on the correction data CRDT. The machine learning module 210 may update the weights of the nodes 170 when the inference data IFDT is false. By updating the weights of the nodes 170, the machine learning module 210 may cause the semiconductor inference model SIMD to output correct inference data IFDT.

Referring to FIG. 11, the computing device 100 may provide an interface 900 for inputting output data and appropriateness of the output data. The computing device 100 may output data to the interface 900 based on the inference data IFDT output by the semiconductor inference model SIMD of FIG. 10. The computing device 100 may determine failure data from the output data based on the inference data IFDT. The output data may include sentences 901 to 904. The sentences 901 to 904 may include inference data IFDT corresponding to each of the sentences 901 to 904.

The computing device 100 may select a sentence whose inference data IFDT exceeds a threshold value as failure data. In embodiments, the threshold value may be set differently. For example, the computing device 100 may select sentences 902 and 904 among the sentences 901 to 904 of the output data as failure data. The computing device 100 may select the failure data by highlighting or otherwise emphasizing the sentences 902 and 904, or the like. The sentences 901 and 903 that are not failure data may not be emphasized or otherwise emphasized.

A user may input correction data CRDT through the interface 900. For example, a user may review the sentences 901 to 904 output by the computing device 100 and input the correction data CRDT indicating the appropriateness of the sentences 901 to 904. The user may determine whether the sentences 901 and 903 are not failure data. The user may determine whether the sentences 902 and 904 are failure data. For example, the user may determine that the sentence 901 is failure data and the sentence 902 is not failure data. Through the input interfaces 905 and 906 corresponding to the sentences 901 and 902, the user may input the correction data CRDT indicating whether the sentences 901 and 902 are failure data into the machine learning module 210.

The machine learning module 210 may correct the values in the inference data IFDT of the sentences 901 and 902 based on the correction data CRDT. For example, the machine learning module 210 may correct the value of the inference data IFDT of the sentence 901 to one (“1”) based on the correction data CRDT through the input interface 905. The machine learning module 210 may correct the value of the inference data IFDT of the sentence 902 to zero (“0”) based on the correction data CRDT through the input interface 906. For example, the machine learning module 210 may correct the value of the inference data IFDT based on the correction data CRDT to correctly generate the incorrectly generated sentences 901 and 902. Accordingly, the machine learning module 210 may output that the sentence 901 is failure data and the sentence 902 is not failure data.

The machine learning module 210 may update the weights of the semiconductor inference model SIMD based on the input data (for example, the semiconductor data SDAT of FIG. 10), the inference data IFDT, and the correction data CRDT. In this way, the semiconductor inference model SIMD on which the supervised learning has been performed may generate inference data IFDT for determining failure data from the input data.

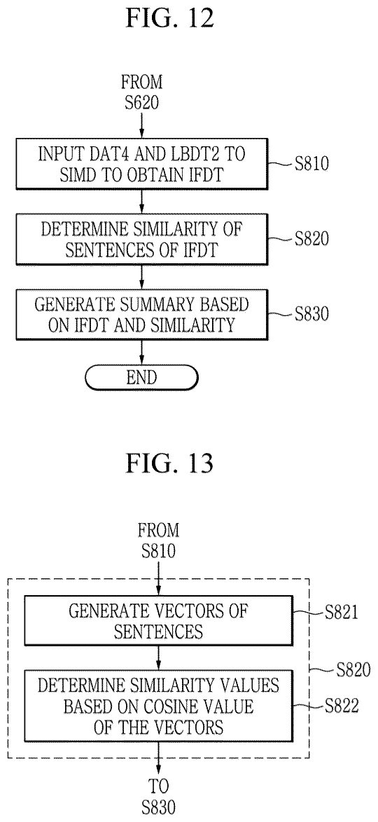

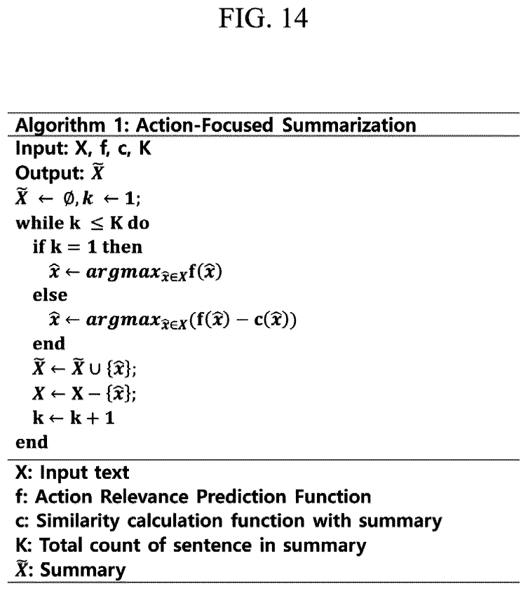

FIGS. 12 and 13 are flowcharts of a summary data generating method performed by the inference module according to an embodiment, and FIG. 14 is a diagram illustrating a summary data generating method performed by the inference module according to an embodiment.

Referring to FIG. 12, the inference module 220 according to one or more embodiments may generate summary data. The inference module 220 may input fourth data DAT4 and second label data LBDT2 corresponding to the fourth data DAT4 into the semiconductor inference model SIMD and obtain inference data IFDT at operation S810. The fourth data DAT4 may be semiconductor equipment data. In one or more embodiments, the fourth data DAT4 may be the same as, or different from, the first data DAT1 of FIG. 3 and the third data DAT3 of FIG. 7.

The inference module 220 may determine similarity values indicating similarities between sentences in the inference data IFDT at operation S820. The inference module 220 may determine the similarity values indicating the similarities between the sentences of the inference data IFDT based on a semiconductor terminology database. The semiconductor terminology database may store hardware information of semiconductor equipment. For example, the storage device 140 of FIG. 2 may be, or may include, a semiconductor terminology database.

FIG. 13 shows an example of operation S820, according to embodiments. Referring to FIG. 13, the inference module 220 may generate vectors of the sentences of the inference data IFDT at operation S821. For example, the inference module 220 may obtain a first vector of the first sentence and a second vector of the second sentence from among the sentences of the inference data IFDT. In one or more embodiments, the inference module 220 may input the first sentence and the second sentence into the semiconductor language model SLMD of FIG. 6, and obtain the first vector and the second vector corresponding to the first sentence and the second sentence from the semiconductor language model SLMD.

The inference module 220 may determine the similarity values based on cosine values of the vectors at operation S822. In embodiments, the inference module 220 may determine the similarity values based on the cosine values of the first vector and the second vector. For example, the inference module 220 may determine that when cosine values of the first vector and the second vector are relatively large, the similarity is high, and therefore the similarity value may be high. The inference module 220 may determine that when the cosine values of the first and second vectors are relatively small, the similarity is low, and therefore the similarity value may be low. The inference module 220 may determine the similarity value based on a comparison in size between the cosine value and the reference value. In some embodiments, the inference module 220 may determine the similarity value using inner products of the first vector and the second vector.

Referring again to FIG. 12, the inference module 220 may generate summary data based on the inference data IFDT and the similarity values at operation S830. In embodiments, the inference module 220 may output the sentence with the largest difference in importance value and similarity value among the sentences in the inference data IFDT.

FIG. 14 illustrates Algorithm 1, which may be an algorithm corresponding to a summary data generating method performed by the inference 220 module according to an embodiment. Referring to FIG. 14, the inference module 220 may generate a summary \tilde{X} based on the input values X, f, c, K using a summarization algorithm. Here, X may denote the input text, and may contain at least one sentence î. f may denote an action relevance prediction function. In one or more embodiments, the action-related prediction function may use the semiconductor inference model SIMD of FIG. 10. For example, the inference module 220 may input the input text X into the semiconductor inference model SIMD. The semiconductor inference model SIMD may output inference data f(\hat{x}) corresponding to at least one sentence \hat{x} of the input text X. The inference data f(\hat{x}) may have a value equal to or greater than zero (“0”) and equal to or less than one (“1”), and a sentence \hat{x} with an inference data f(\hat{x}) close to 1 may correspond to failure action data. According to one or more embodiments, the sentence \hat{x} with the inference data f(\hat{x}) close to one (“1”) may correspond to failure cause data. C may be a similarity calculation function with respect to the summary, and may denote a similarity value indicating the similarity between the sentence \hat{x} and the summary. In embodiments, the description with reference to FIGS. 12 and 13 above may also be applied to the similarity value. In one or more embodiments, K may indicate the total number of sentences in the summary and may be preset by the user.

The inference module 220 may increment the index k from one (“1”) to the input value K. The inference module 220 may generate a summary \tilde{X} for each index k.

The inference module 220 may determine the sentence \hat{x} with the inference data f(\hat{x}) having the maximum value among the input text as the summary data when the index k is equal to one (“1”). In one or more embodiments, the inference module 220 may use the argmax function (arguments of maxima function). For example, the inference module 220 may output the sentence \hat{x} with the inference data f(\hat{x}) having the maximum value when generating first the summary data. The inference module 220 may remove the sentence \hat{x} output as the summary data from the input text X. For example, the sentence \hat{x} used as the summary data once may not be used as summary data again.

The inference module 220 may determine summary data based on the difference between the inference data f(\hat{x}) and a similarity value C(\hat{x}) when the index k is incremented to be equal to two (“2”). For example, the inference module 220 may determine the sentence \hat{x} with the maximum difference between the inference data f(\hat{x}) and the similarity value C(\hat{x}) as the summary data. The inference module 220 may place the sentence \hat{x} determined when the index k is equal to two (“2”) after the sentence \hat{x} determined when the index k is equal to one (“1”). Accordingly, the inference module 220 may determine the failure action data that has low similarity to the sentence \hat{x} determined when the index k is equal to one (“1”) as the summary data. In this way, the inference module 220 may determine the summary data corresponding to each index k until the index kreaches the total number K. The summary data determined by the inference module 220 may be the summary \tilde{X}.

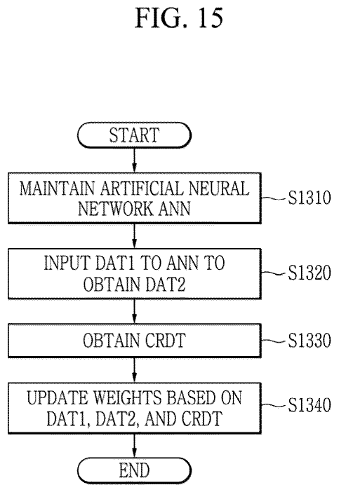

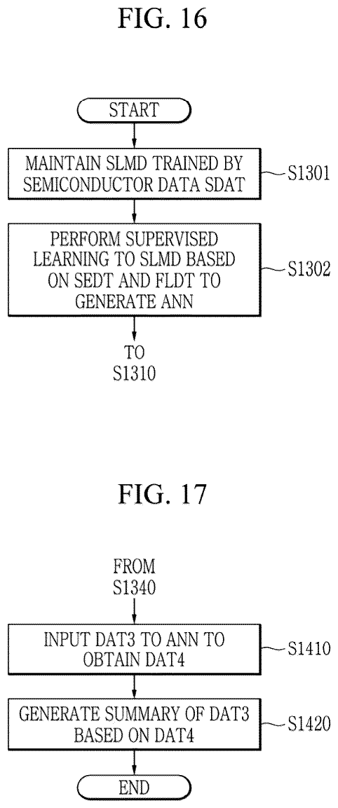

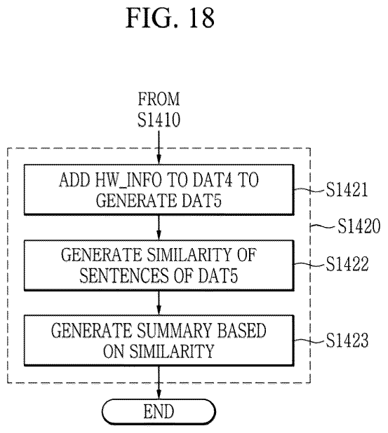

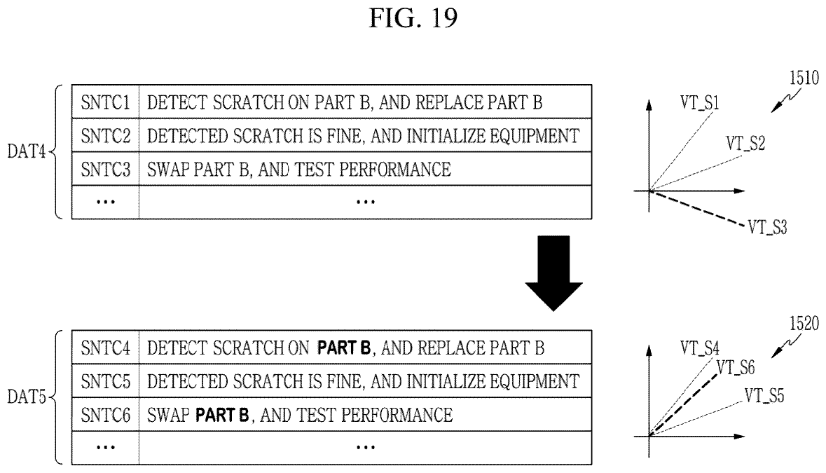

FIGS. 15 and 16 are flowcharts illustrating a language model training method performed by a machine learning module according to an embodiment, FIGS. 17 and 18 are flowcharts illustrating a summary data generating method performed by an inference module according to an embodiment, and FIG. 19 is a diagram illustrating a configuration in which the inference module generates a summary according to an embodiment.

Referring to FIG. 15, the machine learning module 210 according to one or more embodiments may perform supervised learning on an artificial neural network ANN. The machine learning module 210 may maintain the artificial neural network ANN at operation S1310. In one or more embodiments, the artificial neural network ANN may be a large language model (LLM) trained by using a large amount of data. In one or more embodiments, the artificial neural network ANN may be a semiconductor language model trained by using semiconductor data. The artificial neural network ANN may be trained to output failure data from the input data. The failure data may include failure cause data and/or failure action data. In some embodiments, the machine learning module 210 may train the artificial neural network ANN.

The machine learning module 210 may input first data DAT1 to the artificial neural network ANN and obtain second data DAT2 output from the artificial neural network ANN at operation S1320. The first data DAT1 may be semiconductor equipment data. In one or more embodiments, the machine learning module 210 may determine operational reporting data created by a user operating the semiconductor equipment as the first data DAT1. The second data DAT2 may be failure data.

The machine learning module 210 may obtain correction data CRDT representing the appropriateness of the second data DAT2 at operation S1330. In one or more embodiments, the failure data may be failure cause data, and the correction data CRDT may include information about the actual cause of the failure. In one or more embodiments, the failure data may be failure action data, and the correction data CRDT may include information about the effective failure action. The machine learning module 210 may display the second data DAT2 to a user operating the semiconductor equipment. The machine learning module 210 may receive the correction data CRDT corresponding to the second data DAT2 from the user.

The machine learning module 210 may update the weight of the artificial neural network ANN based on the first data DAT1, the second data DAT2, and the correction data CRDT at operation S1340. The machine learning module 210 may correct the second data DAT2 based on the correction data CRDT. The machine learning module 210 may obtain inverted data that inverts the value of the second data DAT2 based on the correction data CRDT. The machine learning module 210 may update the weights so that the artificial neural network ANN outputs the inverted data from the first data DAT1.

For example, the machine learning module 210 may correct the value of the second data DAT2 to zero (“0”) when the correction data CRDT is received for the second data DAT2 that is determined to be failure data. If the machine learning module 210 receives the correction data CRDT for the second data DAT2 that is not determined to be failure data, the machine learning module 210 may correct the value of the second data DAT2 to one (“1”). The machine learning module 210 may update the weight of the artificial neural network ANN such that when the first data DAT1 is input, the corrected second data DAT2 is output.

Referring to FIG. 16, the machine learning module 210 may maintain a semiconductor language model SLMD trained using unsupervised training by using the semiconductor data SDAT at operation S1301. In one or more embodiments, the machine learning module 210 may maintain an trained semiconductor language model SLMD using semiconductor equipment data SEDT. The semiconductor language model SLMD may be a language model configured to receive input data and output a vector corresponding to the input data. For example, the input data may be semiconductor equipment data SEDT. In some embodiments, the machine learning module 210 may use a large language model LLM.

The machine learning module 210 may perform supervised learning on the semiconductor language model SLMD based on a training data set to obtain an artificial neural network ANN at operation S1302. The training data set may include the semiconductor equipment data SEDT and the failure data FLDT. The failure data FLDT may be failure cause data or failure action data of the semiconductor equipment. The machine learning module 210 may train the semiconductor language model SLMD so that the artificial neural network ANN outputs the failure data FLDT from the semiconductor equipment data SEDT. For example, based on the artificial neural network ANN receiving input data, the artificial neural network ANN may generate the importance value of the input data and output failure data FLDT based on the importance value. The importance value may be an indicator of failure relevance and may be a real number ranging from zero (“0”) to one (“1”). The artificial neural network ANN with supervised learning may be used in operation S1310 of FIG. 15.

Referring to FIG. 17, the inference module 220 may input the third data DAT3 to the artificial neural network ANN and obtain fourth data DAT4 output from the artificial neural network ANN at operation S1410. The third data DAT3 may be semiconductor equipment data, and the fourth data DAT4 may be failure data.

The inference module 220 may generate a summary of the third data DAT3 based on the fourth data DAT4 at operation S1420. The inference module 220 may generate a summary that is organized mainly based on the failure data. A configuration in which the inference module 220 generates the summary will be described in detail with reference to FIG. 18.

FIG. 18 illustrates an example of operation S1420, according to embodiments. Referring to FIG. 18, the inference module 220 may add hardware information HW_INFO to the fourth data DAT4 to generate fifth data DAT5 at operation S1421. The inference module 220 may obtain the hardware information HW_INFO from the semiconductor terminology database.

The inference module 220 may determine similarity values indicating similarities between sentences in the fifth data DAT5 at operation S1422. The inference module 220 may obtain a vector corresponding to the fifth data DAT5. For example, the inference module 220 may input the fifth data DAT5 into the semiconductor language model (for example, the semiconductor language model SLMD of FIG. 16) to obtain a vector corresponding to the fifth data DAT5. The semiconductor language model may be a model that is unsupervised-trained with semiconductor equipment data to generate vectors corresponding to the semiconductor equipment data from the semiconductor equipment data. The inference module 220 may determine the similarity value based on the vector. The inference module 220 may determine a cosine similarity based on the vector. The inference module 220 may determine the similarity value based on an inner product of the vector.

Referring to FIGS. 18 and 19, the inference module 220 may detect the hardware included in each sentence SNTC1 to SNTC3 of the fourth data DAT4 based on the hardware information HW_INFO. For example, the fourth data DAT4 may include the first to third sentences SNTC1 to SNTC3 and the like. A spatial representation of the vectors VT_S1 to VT_S3 corresponding to the first to third sentences SNTC1 to SNTC3 may be as shown in graph 1510. In one or more embodiments, the vectors VT_S1 to VT_S3 may be obtained by inputting the first to third sentences SNTC1 to SNTC3 into the semiconductor language model SLMD of FIG. 16.

Based on the hardware information HW_INFO, the inference module may detect part B in the first sentence SNTC1 and detect part B in the third sentence SNTC3. The inference module 220 may transform the fourth data DAT4 based on the detected hardware. In one or more embodiments, the inference module 220 may add the hardware information HW_INFO to each of the sentences SNTC1 to SNTC3 of the fourth data DAT4. In one or more embodiments, the inference module 220 may increase the weight of the hardware included in each of the sentences SNTC1 to SNTC3 of the fourth data DAT4. As such, the inference module 220 may transform the fourth data DAT4 such that the fifth data DAT5 is categorized based on the hardware.

The inference module 220 may transform the fourth data DAT4 to generate the fifth data DAT5. The fifth data DAT5 may include the fourth through sixth sentences SNTC4 to SNTC6. The fourth to sixth sentences SNTC4 to SNTC6 may be the sentences transformed from the first to third sentences SNTC1 to SNTC3 by the inference module 220. When the vectors VT_S4 to VT_S6 corresponding to the fourth to sixth sentences SNTC4 to SNTC6 are displayed in space, the vectors VT_S4 to VT_S6 may be as shown in graph 1520. In graph 1520, it can be seen that the fourth and sixth sentences SNTC4 and SNTC6 associated with part B have increased similarity through the transformation.

In FIG. 19, only two axes are shown in the graphs 1510 and 1520 for ease of illustration, but the vectors VT_S1 to VT_S6 may be arranged in a multi-dimensional space.

Referring again to FIG. 18, the inference module 220 may generate a summary from the fifth data DAT5 based on similarity values at operation S1423.

The inference module 220 may determine the importance values of the sentences in the fifth data DAT5 using the artificial neural network ANN. The inference module 220 may output the sentence with the highest importance value among the sentences of the fifth data DAT5 as first summary data. The inference module 220 may output the sentence with the lowest similarity to the first summary data among the remaining sentences in the fifth data DAT5 as second summary data. The inference module 220 may place the second summary data after the first summary data. The plurality of summary data output by the inference module 220 may form a summary.

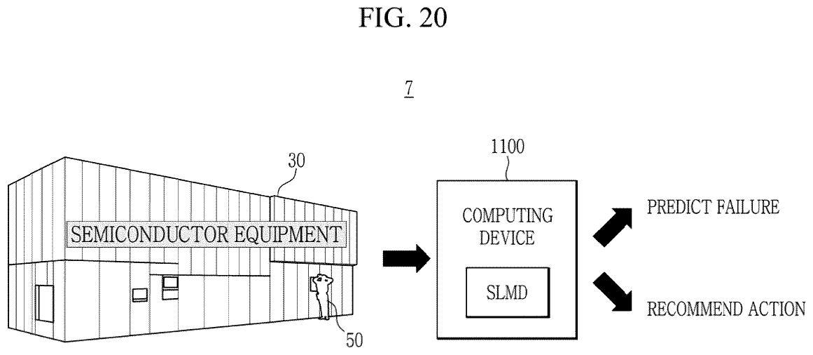

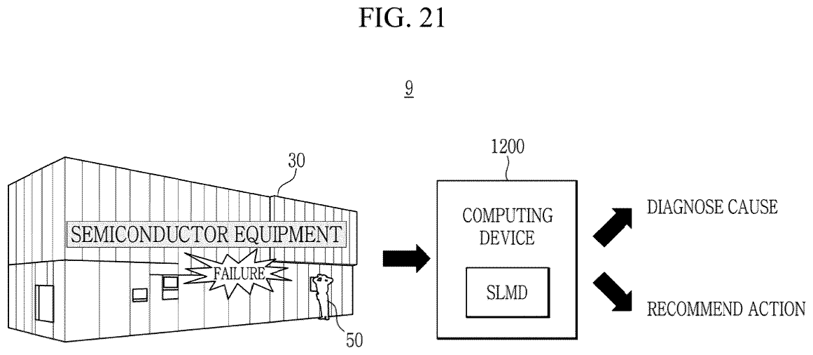

FIG. 20 is a diagram illustrating an operation of a semiconductor system according to an embodiment.

Referring to FIG. 20, a semiconductor system 7 according to an embodiment includes semiconductor equipment 30 and a computing device 1100. The semiconductor equipement 30 shown in FIG. 20 may be similar to the semiconductor equipement 30 shown in FIG. 1, and redundant or duplicative description thereof may be omitted.

The computing device 1100 may monitor the semiconductor equipment 30. For example, the computing device 1100 may receive semiconductor equipment data SDAT and determine a state of the semiconductor equipment 30. The semiconductor equipment data may include operational result data generated by the semiconductor equipment 30. In some embodiment, the semiconductor equipment data SDAT may further include operational reporting data created by a user 50 operating the semiconductor equipment 30.

The computing device 1100 may predict a failure of the semiconductor equipment 30. The computing device 1100 may include a semiconductor language model SLMD. The semiconductor language model SLMD may be trained to output failure data corresponding to input data when receiving the input data. In one or more embodiments, the failure data may include failure prediction data, failure action data, and the like. For example, when the computing device 1100 predicts a failure using the semiconductor language model SLMD, the computing device 1100 may recommend an action method to prevent the predicted failure.

The computing device 1100 may output the action method when the action method requires manipulation of the user 50. For example, the computing device 1100 may display the action method, such as replacing a component, through a user interface, such as a display.

The computing device 1100 may perform the action method when the action method does not require any manipulation by the user 50. For example, the computing device 1100 may autonomously perform the action method, such as auto-repair, initialization, calibration, or parameterization.

The computing device 1100 may recommend the action methods that are more likely to be resolved by using the semiconductor language model SLMD, thereby reducing the possibility of performing incorrect or meaningless actions.

FIG. 21 is a diagram illustrating an operation of a semiconductor system according to an embodiment.

Referring to FIG. 21, a semiconductor system 9 according to an embodiment includes semiconductor equipment 30 and a computing device 1200. The semiconductor equipement 30 shown in FIG. 21 may be similar to the semiconductor equipement 30 shown in FIG. 1, and redundant or duplicative description thereof may be omitted. A failure may occur in the semiconductor equipment 30.

The computing device 1200 may receive semiconductor equipment data and output data corresponding to the failure of the semiconductor equipment 30. The semiconductor equipment data may include operational result data generated by the semiconductor equipment 30. In some embodiments, the semiconductor equipment data may further include operational reporting data created by a user 50 operating the semiconductor equipment 30.

The computing device 1200 may include a semiconductor language model SLMD. The semiconductor language model SLMD may be trained to output failure data corresponding to input data when receiving the input data. In one or more embodiments, the failure data may include failure cause data, failure action data, and the like. In one or more embodiments, the semiconductor language model SLMD may be trained to output a cause of failure of the semiconductor equipment 30. In one or more embodiments, the semiconductor language model SLMD may be trained to output an action method for resolving the failure of the semiconductor equipment 30. For example, the computing device 1200 may output at least one of the cause of the failure and the action method by using the semiconductor language model SLMD.

The computing device 1200 may output a method of action when the action method requires a manipulation by the user 50. For example, the computing device 1200 may display the action method, such as replacing a component, through a user interface, such as a display.

The computing device 1200 may perform the action method when the action method does not require any manipulation by the user 50. For example, the computing device 1200 may autonomously perform the action method, such as auto-repair, initialization, calibration, or parameterization.

The computing device 1200 may recommend the action methods that are more likely to be resolved by using the semiconductor language model SLMD, thereby reducing the possibility of performing incorrect or meaningless actions.

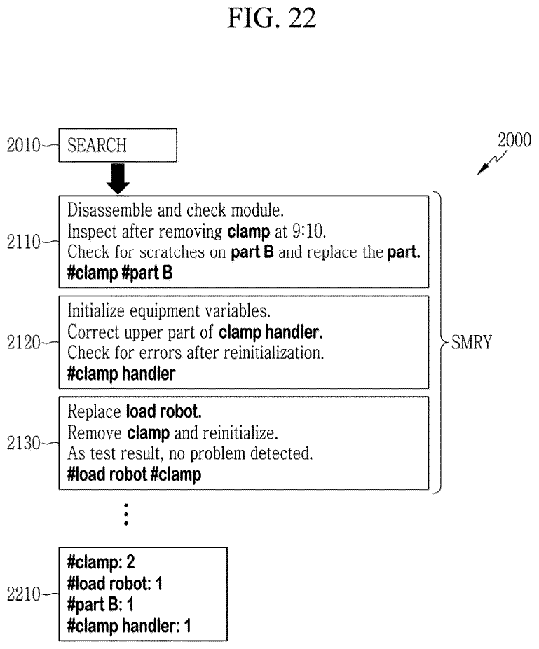

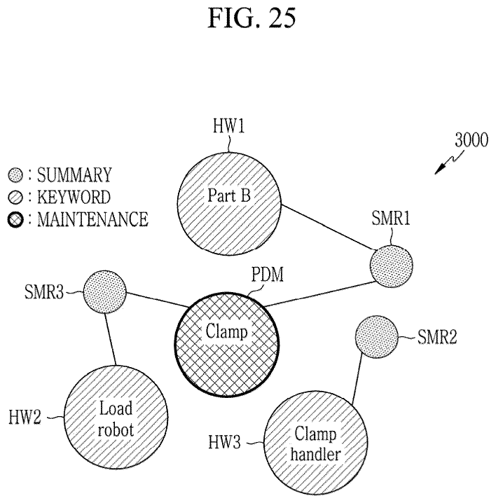

FIGS. 22 to 24 are diagrams illustrating a data management method according to an embodiment, and FIG. 25 is a diagram illustrating a method of generating a relationship graph according to an embodiment.

Referring to FIG. 22, a computing device according to an embodiment may manage a summary SMRY. For example, an artificial neural network may receive semiconductor equipment data and generate an summary SMRY from the semiconductor equipment data. The summary SMRY may include failure action data.

The computing device may provide an interface 2000 for searching for the summary SMRY. The interface 2000 may include a search window 2010. For example, a user may search for data related to the semiconductor equipment through the search window 2010. The computing device may receive a data request from a user through the search window 2010. The computing device may output summaries 2110 to 2130 corresponding to the data request in the summary SMRY.

The computing device may extract information about the hardware included in the summaries 2110 to 2130. For example, the computing device may extract two clamps, one load robot, one part B, and one clamp handler from the summaries 2110 to 2130. The computing device may output the information about the hardware to a region 2210.

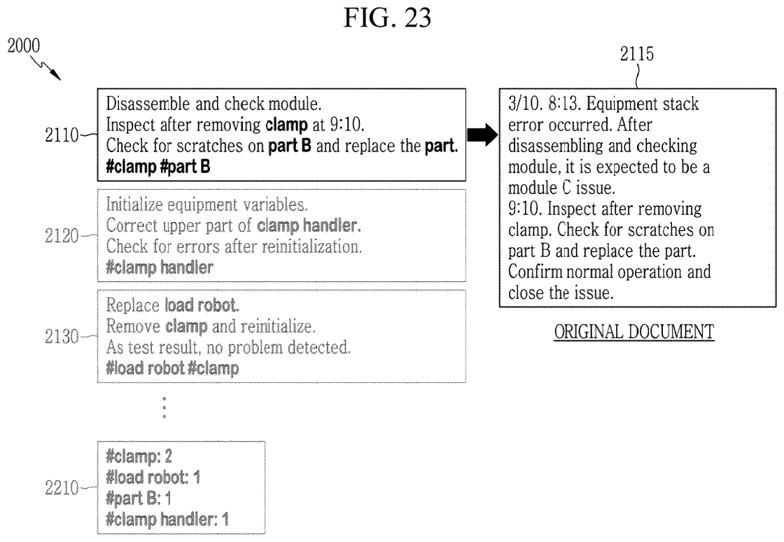

Referring to FIG. 23, the computing device may receive input for a first summary 2110

For example, the user may transmit input for the first summary 2110 to the computing device through the interface 2000

The computing device may output an original document 2115 of the first summary 2110 in response to the input for the first summary 2110. The original document 2115 may include the semiconductor equipment data that was input to the artificial neural network to cause the artificial neural network to generate the first summary 2110.

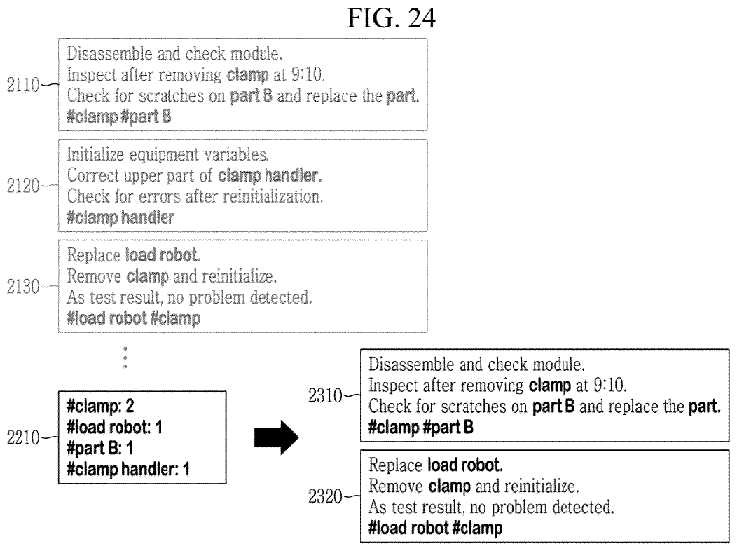

Referring to FIG. 24, the computing device may receive inputs for the hardware through the region 2210. For example, a user may transmit an input corresponding to a clamp to the computing device through the region 2210. In response to the user's input (for example, the input corresponding to the clamp), the computing device may output the summaries 2310 and 2320 that include the clamp among the summaries 2110 to 2130. The summaries 2310 and 2320 may be the same as the summaries 2110 and 2130. In some embodiments, when the computing device receives input for the summaries 2310 and 2320, the computing device may output the original document of the corresponding summary.

Referring to FIG. 25, the computing device according to one or more embodiments may generate a relationship graph 3000 based on the summaries. The graph 3000 may include summaries SMR1 to SMR3, hardware keywords HW1 to HW3, and a maintenance target PDM. For example, the computing device may display the summarys SMR1 through SMR3, the hardware keywords HW1 through HW3, and the maintenance target PDM in a circle. The summaries SMR1 to SMR3 may correspond to the summaries 2110 to 2130 of FIG. 22.

The computing device may connect related objects in the graph 3000 using lines. In one or more embodiments, the computing device may determine the hardware included in the summaries SMR1 to SMR3. For example, the computing device may determine that a first summary SMR1 includes part B HW1 and a clamp PDM, a second summary SMR2 includes a clamp handler HW3, and a third summary SMR3 includes a load robot HW2 and a clamp PDM. The computing device may connect the summaries SMR1 to SMR3 with the hardware keywords HW1 to HW3 and the maintenance target PDM. In some embodiments, the computing device may determine an association between the summaries SMR1 to SMR3 and an association of the summaries SMR1 to SMR3 with the hardware. The computing device may connect the relevant targets based on the determined associations.

The computing device may determine the maintenance target PDM using an artificial neural network. The artificial neural network may predict failures based on semiconductor equipment data. For example, the computing device may predict that a failure will occur in the clamp by using the artificial neural network and display the clamp as a maintenance target PDM in the graph 3000.

In some embodiments, each component or combination of two or more components described with reference to FIGS. 1 to 25 may be implemented as a digital circuit, a programmable or non-programmable logic device or array, an Application Specific Integrated Circuit (ASIC), or the like.

Although certain embodiments of the disclosure are described in detail in detail, the scope of the disclosure is not limited the described embodiments. Various changes and modifications shall be construed to belong to the scope of the disclosure.

What is claimed is:

1. A language model training method comprising:
obtaining first data comprising semiconductor equipment data;
performing preprocessing on the first data to generate second data;
generating a first token from the second data using a mapping table; and
generating a semiconductor language model by performing unsupervised learning on a language model using the first token.

2. The language model training method of claim 1, wherein the obtaining the first data comprises obtaining operation result data from semiconductor equipment, and
wherein the performing the preprocessing on the first data comprises performing the preprocessing on the operational result data to generate the second data.

3. The language model training method of claim 2, wherein the obtaining the first data further comprises obtaining operational reporting data created by a user operating the semiconductor equipment, and
wherein the performing the preprocessing on the first data further comprises performing the preprocessing on the operational result data and the operational reporting data to generate the second data.

4. The language model training method of claim 1, further comprising:
obtaining third data comprising the semiconductor equipment data, and first label data corresponding to the third data; and
generating a semiconductor inference model by performing supervised learning on the semiconductor language model based on the third data and the first label data.

5. The language model training method of claim 4, wherein the obtaining of the third data and the first label data comprises:
obtaining failure action data for resolving a failure of semiconductor equipment from the third data; and
determining a value of the first label data corresponding to the failure action data as a first value.

6. The language model training method of claim 4, wherein the obtaining of the third data and the first label data comprises:
obtaining failure cause data indicating a cause of a failure of semiconductor equipment in the third data; and
determining a value of the first label data corresponding to the failure cause data as a first value.

7. The language model training method of claim 4, further comprising:
inputting the third data and the first label data into the semiconductor inference model, and obtaining inference data output from the semiconductor inference model based on the third data and the first label data;
obtaining correction data indicating an appropriateness of the inference data; and
updating a weight of the semiconductor inference model based on the third data, the first label data, the inference data, and the correction data.

8. The language model training method of claim 4, further comprising:
inputting fourth data comprising the semiconductor equipment data, and second label data corresponding to the fourth data, into the semiconductor inference model, and obtaining inference data output from the semiconductor inference model based on the fourth data and the second label data;
determining a plurality of similarity values indicating similarities between sentences of the inference data based on a semiconductor terminology database; and
generating summary data based on the inference data and the plurality of similarity values.

9. The language model training method of claim 8, wherein the generating of the summary data comprises outputting a sentence having a largest difference between an importance value and a similarity value from among the sentences in the inference data.

10. The language model training method of claim 8, wherein the determining of the plurality of similarity values comprises:
obtaining a first vector corresponding to a first sentence from among the sentences of the inference data, and a second vector corresponding to a second sentence from among the sentences of the inference data; and
determining a similarity value from among the plurality of similarity values based on a cosine value of the first vector and a cosine value of the second vector.

11. The language model training method of claim 10, wherein the obtaining of the first vector and the second vector comprises inputting the first sentence and the second sentence into the semiconductor language model, and obtaining the first vector and the second vector from the semiconductor language model.

12. A language model training method comprising:
inputting first data comprising semiconductor equipment data into an artificial neural network, and obtaining second data comprising failure data output from the artificial neural network;
obtaining correction data indicating an appropriateness of the second data; and
updating a weight of the artificial neural network based on the first data, the second data, and the correction data.

13. The language model training method of claim 12, wherein the obtaining the correction data comprises:
displaying the second data to a user operating semiconductor equipment; and
receiving the correction data corresponding to the second data from the user.

14. The language model training method of claim 13, wherein the updating the weight of the artificial neural network comprises:
obtaining inverted data obtained by inverting a value of the second data based on the correction data; and
updating the weight such that the artificial neural network outputs the inverted data based on the first data.

15. The language model training method of claim 12, further comprising:
inputting third data comprising the semiconductor equipment data into the artificial neural network, and obtaining fourth data comprising the failure data output from the artificial neural network; and
generating summary data of the third data based on the fourth data.

16. The language model training method of claim 15, wherein the generating the summary data comprises:
adding hardware information to the fourth data based on a semiconductor terminology database to generate fifth data;
determining a plurality of similarity values indicating similarities between sentences of the fifth data; and
generating the summary data based on the fifth data based on the plurality of similarity values.

17. The language model training method of claim 16, wherein the generating the summary data comprises:
determining a plurality of importance values corresponding to the sentences of the fifth data using the artificial neural network;
outputting a first sentence having a highest importance value from among the sentences of the fifth data; and
outputting a second sentence having a lowest similarity to the first sentence among the sentences.

18. The language model training method of claim 16, wherein the determining of the plurality of similarity values comprises:
obtaining a vector corresponding to the fifth data; and
determining a similarity value from among the plurality of similarity values based on the vector.

19. The language model training method of claim 18, wherein the determining of the plurality of similarity values comprises:
obtaining a semiconductor language model that is trained using unsupervised training based on the semiconductor equipment data to generate a vector corresponding to the semiconductor equipment data;
inputting the fifth data into the semiconductor language model to obtain the vector corresponding to the fifth data; and
determining the a similarity value from among the plurality of similarity values based on the vector.

20. A language model training method comprising:
performing unsupervised learning on an artificial neural network using semiconductor equipment data to generate a semiconductor language model; and
performing supervised learning on the semiconductor language model based on the semiconductor equipment data, label data, and correction data to generate a semiconductor inference model.
